(19) United States
(12) Patent Application Publication
(10) Pub. No.: US 2026/0218883 A1
(43) Pub. Date: Jul. 30, 2026

(54) Lens adjustment linkage mechanism and illuminating device with same

(71) Applicant: Guangzhou Haoyang Electronic Co., Ltd., Guangzhou (CN)

(72) Inventors: Weikai JIANG, Guangzhou (CN); Chaoyi CHEN, Guangzhou (CN); Zhiqiang CHEN, Guangzhou (CN); Mingfu LIAO, Guangzhou (CN); Weiquan JIANG, Guangzhou (CN)

(21) Appl. No.: 19/375,688

(22) Filed: Oct. 31, 2025

(30) Foreign Application Priority Data
Jan. 25, 2025 (CN) 202520173923.0

(51) Int. Cl. F21V 14/06; F21V 17/02

(52) U.S. Cl. CPC F21V 14/06; F21V 17/02

(57) ABSTRACT

A lens adjustment linkage mechanism for adjusting a lens assembly, including a base plate; a single driving motor for providing a driving force; at least two transmission rods driven by the driving motor, with an end of each transmission rod connected to the lens assembly; and a transmission assembly connected to a rotating shaft of the driving motor and the at least two transmission rods, which is configured to transmit the driving force of the driving motor to the at least two transmission rods to drive the lens assembly to move along a length direction of the at least two transmission rods.

### CROSS REFERENCE TO RELATED APPLICATIONS

The present application claims priority from Chinese Application No. CN 202520173923.0 filed on Jan. 25, 2025, all of which are hereby incorporated herein by reference.

### TECHNICAL FIELD

The present disclosure relates to the technical field of illuminating device, especially for stage performance, and in particular, to a lens adjustment linkage mechanism and an illuminating device with the same.

### BACKGROUND

Illuminating devices, especially for stage performance, such as wash lights, are usually equipped with at least one set of lens assembly that can move linearly along a light path to adjust the shape of the light spot projected. In particular, a focusing lens assembly is provided to change the clarity of the light spot, and a magnifying lens assembly is provided to adjust the size of the light spot, thereby achieving a variety of light spot effects. Such lens assembly is often driven by multiple lead screw motors of the adjustment mechanism. Although this multi-motor driving approach can ensure stable movement of the lens assembly due to uniform stress bearing, it also brings problems.

For example, the illuminating device is difficult to achieve compact and lightweight design due to larger volume of the multiple motors. This imposes limitation on application scenarios requiring compact design and portability. In addition, although this design theoretically provides more stable movement of the lens assembly, in actual operation, simultaneous driving of the multiple motors usually brings synchronization errors, resulting in problems such as unsmooth movement.

It is therefore desirable to provide a more efficient and compact adjustment mechanism to improves the lens adjustment of the illuminating device.

### SUMMARY

The present disclosure provides a lens adjustment linkage mechanism and an illuminating device with the same, which can effectively reduce the volume occupied by the lens adjustment mechanism, as well as ensure stable movement of the lens assembly during lens adjustment.

One aspect of the present disclosure provides a lens adjustment linkage mechanism for adjusting a lens assembly, which includes a base plate; a single driving motor for providing a driving force; at least two transmission rods driven by the driving motor, with an end of each of the transmission rods connected to the lens assembly; and a transmission assembly connected to a rotating shaft of the driving motor and the at least two transmission rods, which is configured to transmit the driving force of the driving motor to the transmission rods, so as to drive the lens assembly to move along a length direction of the transmission rods.

In the linkage mechanism of the present disclosure, with the transmission assembly connected to the rotating shaft of the driving motor and all the transmission rods, only one driving motor is required to achieve synchronous movement of the multiple transmission rods, so as to drive the lens assembly to move along the length direction of the transmission rods. As a result, the number of the possible driving motors used in the prior art is greatly reduced. This effectively reduces the volume occupied by the lens adjustment mechanism, and also reduces noise caused by the motors in the prior art. In addition, with the configuration of the at least two transmission rods, the lens assembly can be kept in force balance and thus move stably.

In a particular embodiment of the present disclosure, in order to allow the transmission rods not to protrude beyond the lens assembly when the lens assembly moves towards the base plate, the end of each transmission rod is fixedly connected to the lens assembly, and the rotational movement of the driving motor is converted by the transmission assembly into the liner movement of the transmission rods along the length direction thereof, so that the lens assembly is driven to move in a direction close to or away from the base plate. This can achieve a more compact design.

Preferably, each transmission rod may be a lead screw, and the transmission assembly may include lead screw nuts sleeved outside the corresponding transmission rod and driven wheels coaxially and fixedly connected to the corresponding lead screw nut. The lead screw nuts are rotatably connected to the base plate, and the driven wheels are driven by the driving motor to rotate. In such configuration, the lead screw nut rotates along with the driving motor, due to cooperation of the lead screw nut and the lead screw, the lead screw moves up and down relative to the base plate, as the lead screw nut is rotatably connected to the base plate, thereby achieving efficient and stable conversion of the rotational movement of the driving motor to the linear movement.

As the lead screw nuts are required to rotatably connect to the base plate, the mounting of the transmission assembly mounting would be limited by the mounting of the lead screw nut. According to a more preferable embodiment, the transmission assembly may further include first supports fixedly connected to the base plate. Each first support is of a U-shaped structure with each end provided with one pivot hole for the corresponding transmission rod to pass through. Each end of each lead screw nut is pivotally connected to the pivot hole of the corresponding first support via a bearing. Through the first support, the transmission assembly can be mounted in a specific position based on actual design requirements, which facilitates installation and subsequent maintenance.

Because of the advantages of high precision, low maintenance, and low noise, the driving force of the driving motor may be transmitted to the driven wheels through the synchronous belt according to a preferable embodiment. For the purpose of this, the transmission assembly may further include a driving wheel fixedly connected to the rotating shaft of the driving motor, and a synchronous belt engaged with the driving wheel and the driven wheels.

In this case, the lens adjustment mechanism may further include at least one support post configured to keep the synchronous belt in a tensioned state. With the support post, the synchronous belt can be always kept in the tensioned state during transmission, which can enhance reliability and efficiency of the entire transmission assembly.

Compared to the synchronous belt, driving transmission by a transmission gear usually provides a constant and accurate transmission ratio, allowing the movement of the object to be detected more accurately. In an alternative embodiment of the present disclosure, the driving force of the driving motor may also be transmitted by gear transmission. In such case, the transmission assembly may further include a driving wheel fixedly connected to the rotating shaft of the driving motor and a transmission gear engaged with the driving wheel and the driven wheels to transmit the driving force of the driving motor to the transmission rods.

Preferably, the transmission gear is in form of an internal gear, and the driving wheel and the driven wheels are located within an internal gear ring of the transmission gear. Such configuration forms a planetary-gear transmission structure, which ensures efficient transmission while making the structure of the transmission assembly more compact. In addition, this transmission way also has high impact resistance load capability, thereby providing good reliability and durability.

To facilitate keeping the lens assembly in a force balance, so as to avoid stuttering or unsmooth movement, the driving motor in the present disclosure is preferred to be located at or near the centre of the base plate, and the transmission rods are arranged around the periphery of the base plate. Such reasonable arrangement also provides more mounting space for other components, thereby further achieving compact design.

One aspect of the present disclosure provides an illuminating device, including a light head having a light outlet. The light head internally includes a lens assembly, the lens adjustment linkage mechanisms in each case mentioned above for adjusting the lens assembly, a light-emitting element, and a heat dissipator. The light-emitting element and the lens assembly are disposed in sequence in a light-emitting direction, and a distance between the lens assembly and the light-emitting element can be adjusted under the drive of the lens adjustment mechanism. Under the driving of the lens adjustment mechanism, the divergence angle of the light emitted from the light-emitting element can be changed by the lens assembly, resulting in a variety of light spots with change of the distance between the lens assembly and the light-emitting element.

Preferably, the light-emitting element may be disposed on the base plate of the lens adjustment linkage mechanism. This eliminates additional elements to install the light-emitting element, thus making the structure in the illuminating device more compact, and also effectively reducing the whole weight.

In a particular embodiment of the present disclosure, the heat dissipator may include a mounting plate and a plurality of heat dissipation fins disposed on one side of the mounting plate away from the light-emitting element, and the base plate may be defined by the mounting plate of the heat sink. In such arrangement, the motor may be disposed on one side of the mounting plate away from the light-emitting element, the transmission rods pass through the mounting plate, and an area of the heat dissipation fins may form an avoidance space. When the lens assembly moves in a direction close to the base plate, one end of the transmission rods away from the lens assembly may enter the avoidance space, resulting in a more compact structure, and further reducing the size of the light head.

Further advantages, features and potential applications of the present invention may be gathered from the description which follows, in conjunction with the embodiments illustrated in the drawings.

### BRIEF DESCRIPTION OF THE DRAWINGS

FIG. 1 is a perspective view of a lens adjustment linkage mechanisms according to an embodiment of the present disclosure;

FIG. 2 is a view showing disassembly of a transmission rod from a transmission assembly;

FIG. 3 is a view showing assembly of the transmission rod with the transmission assembly;

FIG. 4 is a perspective view of a lens adjustment linkage mechanisms according to another embodiment of the present disclosure;

FIG. 5 is a a perspective view of an illuminating device according to an embodiment of the present disclosure;

FIG. 6 is a view showing an inner structure of a light head according to an embodiment of the present disclosure;

FIG. 7 is another view showing the inner structure of the light head according to an alternative embodiment of the present disclosure; and

FIG. 8 is an exploded view of FIG. 7.

### DETAILED DESCRIPTION OF THE EMBODIMENTS

The accompanying drawings are merely for purposes of illustration and should not understood as limitation of the patent. In order to better illustrate the embodiment, some parts in the accompanying drawings are omitted, enlarged or reduced and do not represent the actual size of a product. It is understandable to those skilled in the art that some well-known structures and descriptions thereof may be omitted in the accompanying drawings. The positional relationships described in the accompanying drawings are merely for purpose of illustration and should not be understood as limitation of the patent.

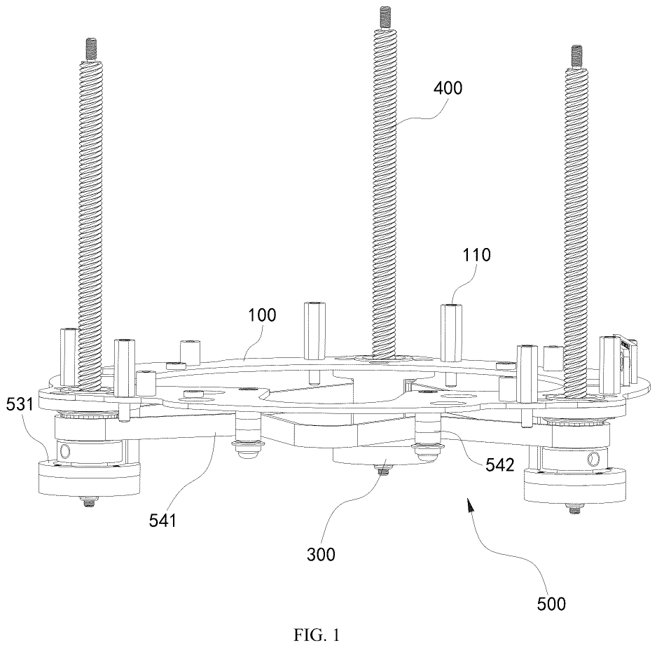

FIG. 1 provides a lens adjustment linkage mechanism for adjusting a lens assembly 200 according to an embodiment. The lens adjustment linkage mechanism includes a base plate 100; a single driving motor 300 fastened relative to the base plate 100; at least two transmission rods 400 driven by the driving motor 300, with an end of each of the transmission rods 400 connected to the lens assembly 200; and a transmission assembly 500 connected to a rotating shaft of the driving motor 300 and all the transmission rods 400, which is configured to transmit the driving force of the driving motor 300 to the transmission rods 400, so as to drive the lens assembly 200 to move along the length direction of the transmission rods 400.

With the transmission assembly 500 connected to the rotating shaft of the driving motor 300 and all the transmission rods 400, a linkage-mode driving is formed to achieve synchronous movement of the multiple transmission rods 400 driven by the signal motor 300, so as to drive the lens assembly 200 to move along the length direction of the transmission rods 400. Such linkage configuration requires only one driving motor 300, which greatly reduces the number of the possible driving motors used in the prior art, thereby effectively reducing the volume occupied by the lens adjustment mechanism, and also reducing noise caused by the motor. In addition, the lens assembly 200 is driven to move through at least two transmission rods 400, which thus can be kept in force balance to move stably.

The lens of the lens assembly 200 may be selected from a Fresnel lens, a focusing lens, or a magnifying lens based on actual design needs.

According to a preferable embodiment, a plurality of limit pillars 110 is further included for limiting the travel of the lens assembly 200 in a direction close to the base plate 100, which can avoid collisions between the lens assembly 200 and the base plate 100 or other components.

In a particular embodiment, the end of the transmission rod 400 is fixedly connected to the lens assembly 200, and the rotational movement of the driving motor 300 is converted by the transmission assembly 500 into the movement of the transmission rods 400 along its own length direction, so as to drive the lens assembly 200 to move in a direction close to or away from the base plate 100. In such configuration, the transmission rod 400 moves up and down relative to the base plate 100 along its own length direction, so that when the lens assembly 200 moves towards the base plate 100, the transmission rods 400 do not protrude beyond the lens assembly 200, resulting in a more compact structure. Preferably, the transmission rods 400 are fixedly connected to the lens assembly 200 by screws, or any other common fasteners.

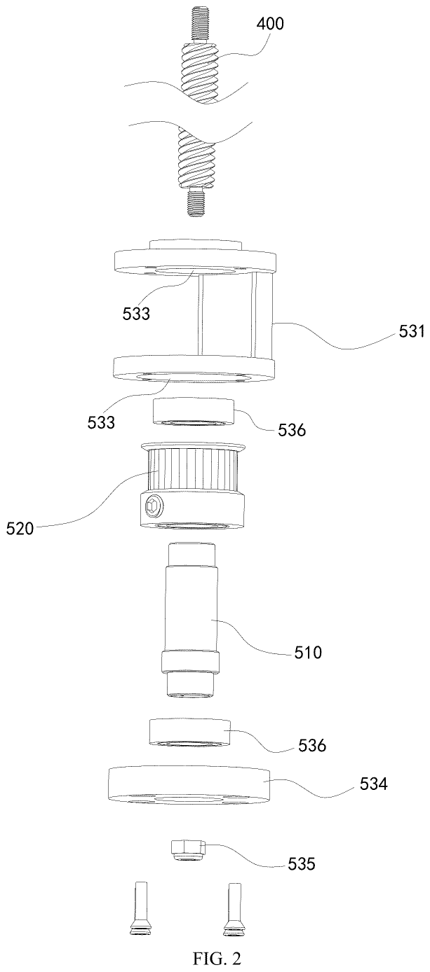

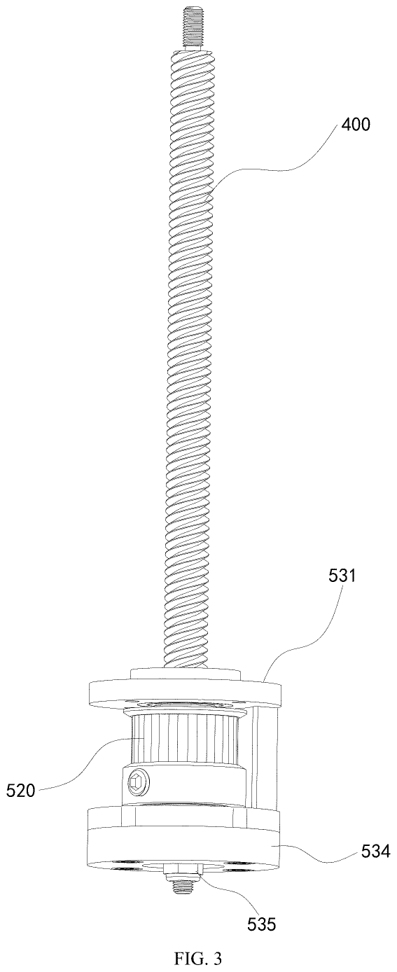

In combination with FIG. 2 and FIG. 3, each transmission rod 400 in this embodiment is a lead screw. The transmission assembly 500 includes lead screw nuts 510, each of the lead screw nuts 510 sleeved outside each of the transmission rods 400, and driven wheels 520 coaxially and fixedly connected to the lead screw nuts 510. The lead screw nuts 510 are rotatably connected to the base plate 100. The driven wheels 520 are driven by the driving motor 300 to rotate. The lead screws and the lead screw nut 510s cooperate with each other. In such easy way, the lead screw nuts 510 rotate along with the driving motor 300, and the lead screw moves up and down relative to the base plate 100 as the lead screw nuts 510 are rotatably connected to the base plate 100, thereby achieving efficient and stable conversion of the rotational movement of the driving motor 300 to the linear movement. Preferably, the driven wheels 520 are fixedly connected to the respective lead screw nut 510 by screws, or any other common fasteners.

The transmission assembly 500 in this embodiment further includes first supports 531 fixedly connected to the base plate 100. Each first support 531 is of a U-shaped structure with each end provided with one pivot hole 533 for the corresponding transmission rod 400 to pass through. Each end of the lead screw nut 510 is pivotally connected to the corresponding pivot hole 533 of the corresponding first support 531 via a bearing 536. The first supports 531 can be mounted in a specific position based on actual design requirements without limitation of the mounting position of the lead screw nuts 510, which facilitates installation and subsequent maintenance. Preferably, an end surface of each first support 531 is fixedly mounted onto the base plate 100, and the base plate 100 is provided with a perforation hole for the transmission rod 400 to pass through corresponding to the pivot hole 533.

In this embodiment, each transmission rod 400 simultaneously passes through the two pivot holes 533 of the corresponding first support 531. A cover plate 534 is fixedly connected to one end of the first support 531 away from the lens assembly 200. The cover plate 534 is also provided with a through hole for the transmission rod 400 to pass through. The end of the transmission rod 400 close to the through hole is connected with an anti-loosing nut 535. With the cooperation of the cover plate 534 and the anti-loosing nut 535 the transmission rod 400 avoids loosening from the transmission assembly 500.

In an alternative embedment of the present disclosure, the transmission rod 400 is a lead screw, and the lens assembly 200 is fixedly connected to a nut, through which the lens assembly 200 is slidably connected to the transmission rod 400. In this way, when the driving motor 300 drives the lead screw to rotate under the driving force transmitted by the transmission assembly 500, the lens assembly 200 moves up and down in a length direction of the lead screw.

Referring back to FIG. 1, the transmission assembly 500 further includes a synchronous belt 541 and a driving wheel 310 fixedly connected to the rotating shaft of the driving motor 300. The synchronous belt 541 is engaged with the driving wheel 310 and the driven wheels 520. In this embodiment, the driving force of the driving motor 300 is transmitted to the driven wheel 520 through the synchronous belt 541, which has the advantages of high precision, low maintenance, and low noise.

In order to keep the synchronous belt 541 in the tensioned state during transmission and enhance reliability and efficiency of the entire transmission assembly 500, support posts 542 are further included for keeping the synchronous belt 541 always in the tensioned state.

Preferably, in a case that the driving motor 300 is located at the central of the base plate 100, the support posts 542 are disposed around the driving motor 300, ensuring that the synchronous belt 541 is always engaged with the driving wheel 310 of the driving motor 300 and all the driven wheels 520.

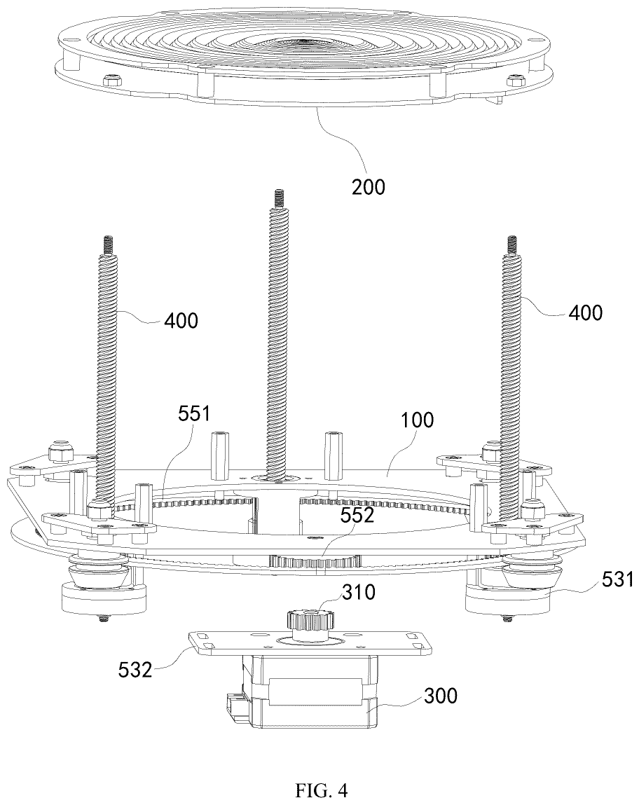

FIG. 4 provides another lens adjustment linkage mechanism according to an alternative embodiment. In this embodiment, the driving force of the driving motor 300 is transmitted to the driven wheel 520 through a transmission gear 551 which is engaged with the he driving wheel 310 of the driving motor 300 and all the driven wheels 520. Compared to the synchronous belt 541, the transmission gear 551 provides a constant and accurate transmission ratio, making the movement of the lens assembly 200 can be detected more accurately.

Preferably the transmission gear 551 is an internal gear, and the driving wheel 310 and all the driven wheels 520 are located within the internal gear ring of the transmission gear 551. The planetary-gear transmission structure ensures efficient transmission while making the structure of the transmission assembly 500 is more compact. In addition, this transmission way also has high impact resistance load capability, thereby providing good reliability and durability.

Preferably, in a case that the driving motor 300 is located at the central of the base plate 100, the driving wheel 310 is engaged with the driven wheels 520 through a transition gear 552.

The driving motor 300 can be located at the centre of the base plate 100 or close to the centre of the base plate 100, and the transmission rods 400 are arranged around the periphery of the base plate 100. Such arrangement facilitates keeping the lens assembly 200 in a force balance, which effectively avoids stuttering or unsmooth movement. In addition, such reasonable arrangement also provides more mounting space for other components, thereby further achieving compact design.

To drive the lens assembly 200 more smoothly, three transmission rods 400 are preferably provided, which are evenly arranged at intervals around the periphery of the base plate 100.

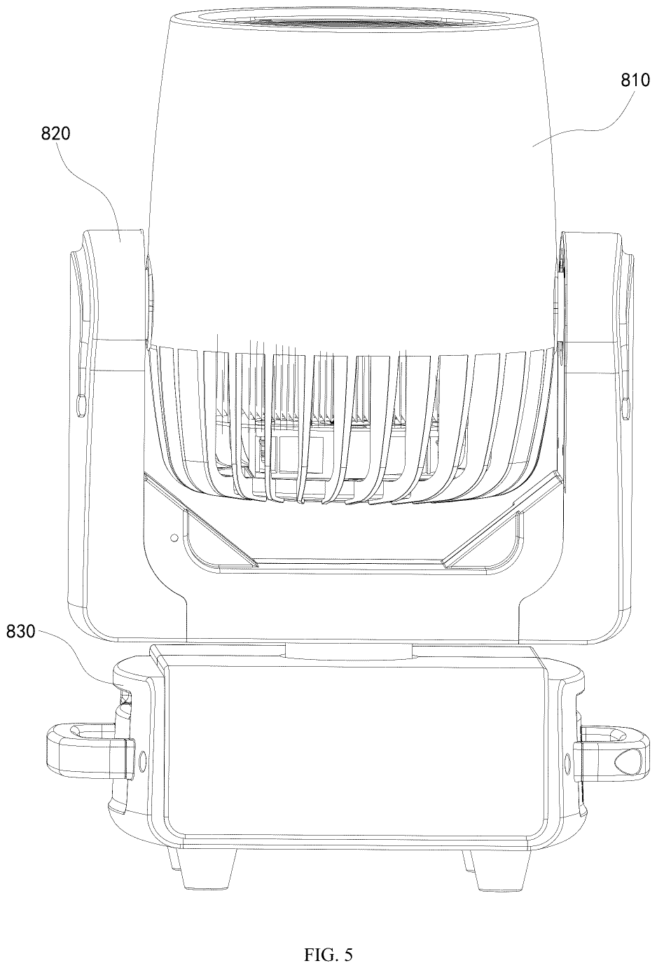

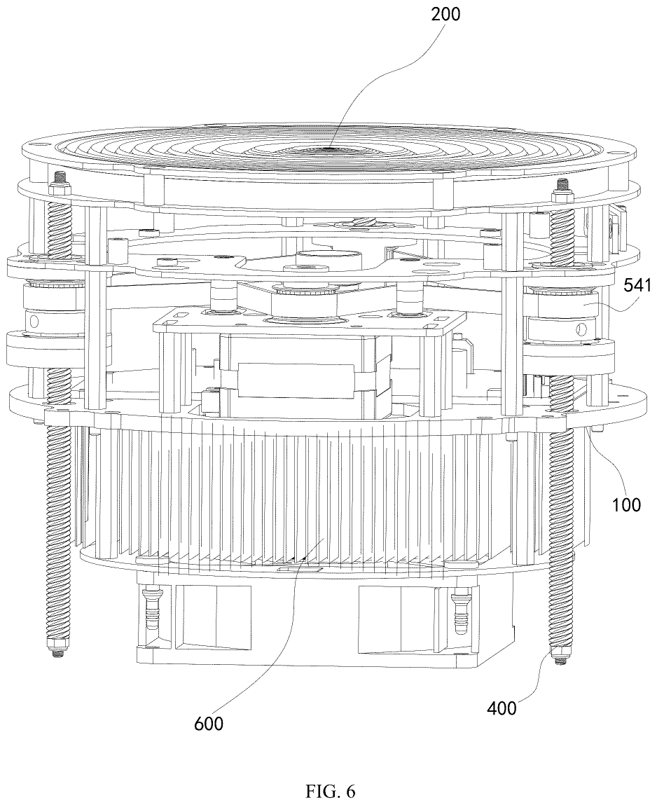

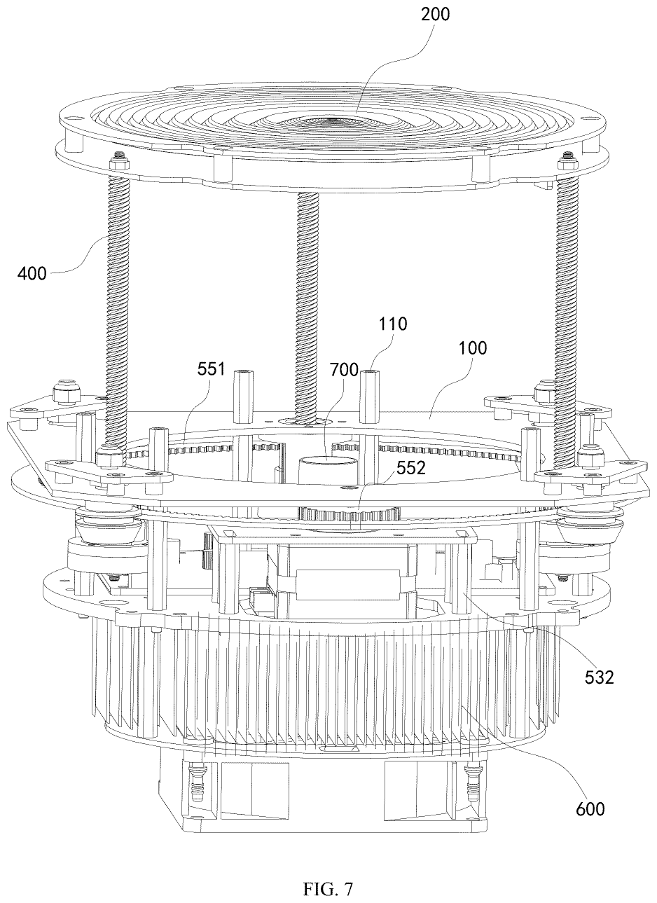

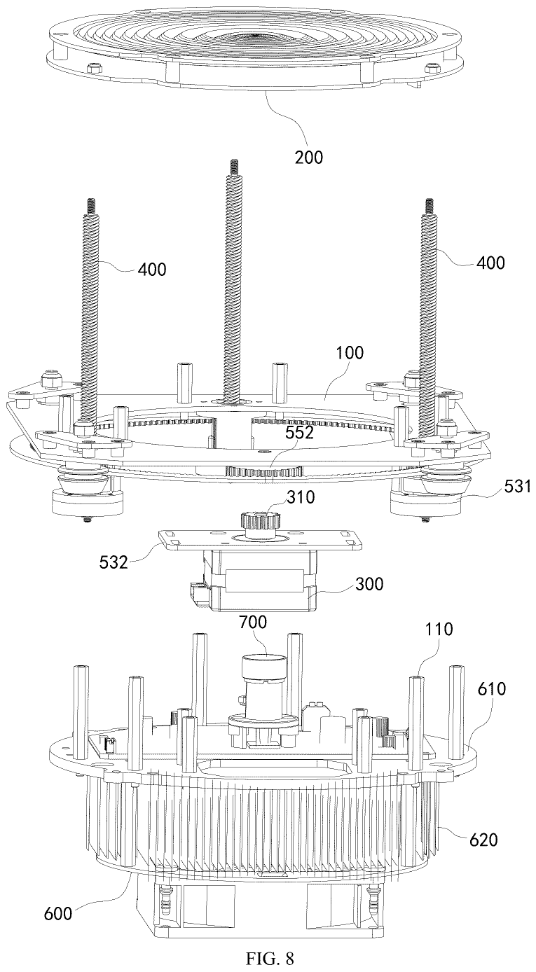

FIG. 5 depicts a perspective view of an illuminating device including a light head 810 having a light outlet. FIG. 6 illustrates a view showing the inner structure of the light head according to an embodiment of the present disclosure, in which the driving force of the driving motor 300 is transmitted to the driven wheels 520 through the synchronous belt 541. In FIG. 6, the lens assembly 200 is driven to a first position closest to the base plate 100. FIG. 7 illustrates another view showing the inner structure of the light head according to an alternative embodiment of the present disclosure, in which the driving force of the driving motor 300 is transmitted to the driven wheels 520 through the transmission gear 551. In FIG. 7, the lens assembly 200 is driven to a second position farthest away from the base plate 100. FIG. 8 illustrates an exploded view of FIG. 7. As shown, the light head 810 internally includes the lens assembly 200, the lens adjustment mechanisms in any case mentioned above for adjusting the lens assembly 200, a light-emitting element, and a heat dissipator 600. The lens assembly 200 and the light-emitting element are disposed in sequence in a light-emitting direction. A distance between the lens assembly 200 and the light-emitting element can be changed under driving of the lens adjustment mechanism. In such configuration, under driving of the lens adjustment mechanism, the divergence angle of the light emitted from the light-emitting element can be changed by the lens assembly 200 to form a variety of light spots.

The illuminating device in this embodiment is preferably a wash light.

As shown in FIG. 5, the illuminating device in the present embodiment further includes a support arm 820 pivotally connected to the light head 810, and a base 830 pivotally connected to the support arm 820. In such configuration, the light head 810 can project light spots onto a target plane from multiple angles, thereby enriching stage effects.

The light-emitting element is preferably disposed on the base plate 100. This eliminates additional elements to mount the light-emitting element, making the structure inside the illuminating device more compact, and effectively reducing the weight.

As shown in FIGS. 6-8, the heat dissipator 600 includes a mounting plate 610. The driving motor 300 is fixedly mounted onto the mounting plate through a second support 532. The transmission rods 400 are rotatably connected to the base plate 100 through the corresponding first support 531. An avoidance space is formed between the base plate 100 and the mounting plate 610 for the transmission rods 400 to pass through.

Additionally, an additional light plate may be provided to mount a plurality of light-emitting elements.

Preferably, the light-emitting element in this embodiment is an LED chip, and further includes a light guide 700 configured to mix the light emitted by the LED chip. An incident surface of the light guide 700 is in close contact with the LED chip. Under the driving of the lens adjustment mechanism, the lens assembly 200 can move towards or away from a light-emitting surface of the light guide 700.

The heat dissipator 600 in this embodiment further includes a plurality of heat dissipation fins 620 disposed on one side of the mounting plate 610 away from the light-emitting element. The base plate 100 may be the mounting plate 610 of the heat dissipator 600 in some embodiments. In such arrangement, the motor 300 may be disposed on one side of the mounting plate 610 away from the light-emitting element, the transmission rods 400 passe through the mounting plate 610, and an area of the heat dissipation fins 620 may form the avoidance space. When the lens assembly 200 moves in a direction close to the base plate 100, one end of the transmission rods 400 away from the lens assembly 200 may enter the avoidance space, resulting in a more compact structure, and allowing the size of the light head 810 to be further reduced.

Obviously, the above-mentioned embodiments of the present disclosure are merely examples provided to clearly illustrate the present disclosure, and are not intended to limit the implementations of the present disclosure. For those of ordinary skill in the art, other variations or modifications in different forms may be made on the basis of the above description. It is unnecessary and impossible to exhaust all the implementations here. Any modifications, equivalent replacements, or improvements made within the spirit and principles of the present disclosure shall fall within the protection scope of the claims of the present disclosure.

What's claimed is:

1. A lens adjustment linkage mechanism for adjusting a lens assembly, comprising:
a base plate;
a single driving motor for providing a driving force;
at least two transmission rods driven by the driving motor, with an end of each transmission rod connected to the lens assembly; and
a transmission assembly connected to a rotating shaft of the driving motor and the at least two transmission rods, which is configured to transmit the driving force of the driving motor to the at least two transmission rods to drive the lens assembly to move along a length direction of the at least two transmission rods.

2. The lens adjustment linkage mechanism according to claim 1, wherein the end of each of the transmission rods is fixedly connected to the lens assembly, and the transmission assembly is configured to convert a rotational movement of the driving motor into a liner movement of the at least two transmission rods along the length direction thereof to drive the lens assembly to move in a direction close to or away from the base plate.

3. The lens adjustment linkage mechanism according to claim 2, wherein each of the at least two transmission rods is a lead screw, the transmission assembly comprises lead screw nuts sleeved outside the corresponding transmission rod, and driven wheels coaxially and fixedly connected to the corresponding lead screw nut, the lead screw nuts are rotatably connected to the base plate, and the driven wheels are driven by the driving motor to rotate.

4. The lens adjustment linkage mechanism according to claim 3, wherein the transmission assembly further comprises first supports fixedly connected to the base plate, each of the first supports is of a U-shaped structure with each end provided with one pivot hole for the corresponding transmission rod to pass through, and each end of each lead screw nut is pivotally connected to the pivot hole of the corresponding first support via a bearing.

5. The lens adjustment linkage mechanism according to claim 3, wherein the transmission assembly further comprises a driving wheel fixedly connected to the rotating shaft of the driving motor, and a synchronous belt engaged with the driving wheel and the driven wheels.

6. The lens adjustment linkage mechanism according to claim 5, wherein the transmission assembly further comprises at least one support pillar configured to keep the synchronous belt in a tensioned state.

7. The lens adjustment linkage mechanism according to claim 3, wherein the transmission assembly further comprises a driving wheel fixedly connected to the rotating shaft of the driving motor, and a transmission gear engaged with the driving wheel and the driven wheels to transmit the driving force of the driving motor to the at least two transmission rods.

8. The lens adjustment linkage mechanism according to claim 7, wherein the transmission gear is in form of an internal gear, and the driving wheel and the driven wheels are located within an internal gear ring of the transmission gear.

9. The lens adjustment linkage mechanism according to claim 1, wherein the driving motor is located at a centre of the base plate or close to a centre of the base plate, and the at least two transmission rods are arranged around a periphery of the base plate.

10. An illuminating device, comprising a light head having a light outlet, in which an lens assembly, the lens adjustment linkage mechanism according to claim 1, a light-emitting element, and a heat dissipator are provided, wherein the light-emitting element and the lens assembly are disposed in sequence in a light-emitting direction, and a distance between the lens assembly and the light-emitting element is adjustable under driving of the lens adjustment linkage mechanism.

11. The illuminating device according to claim 10, wherein the light-emitting element is arranged on the base plate of the lens adjustment linkage mechanism.

12. The illuminating device according to claim 10, wherein the heat dissipator comprises a mounting plate and a plurality of heat dissipation fins disposed on one side of the mounting plate away from the light-emitting element, and the base plate of the lens adjustment linkage mechanism is defined by the mounting plate of the heat dissipator.
